(19) United States
(12) Patent Application Publication
(10) Pub. No.: US 2025/0210705 A1
(43) Pub. Date: Jun. 26, 2025

(54) ALKALI METAL-CONTAINING POLYMER, AND ELECTROLYTE COMPOSITION AND BATTERY CONTAINING SAME

(71) Applicants: SUMITOMO CHEMICAL COMPANY, LIMITED, Chuo-ku, Tokyo (JP); Kyoto University, Kyoto-shi, Kyoto (JP)

(72) Inventors: Hideto NAKAJIMA, Niihama-shi, Ehime (JP); Koki SUWA, Niihama-shi, Ehime (JP); Makoto OUCHI, Kyoto-shi, Kyoto (JP); Izumi YAMADA, Kyoto-shi, Kyoto (JP)

(21) Appl. No.: 18/850,726

(22) PCT Filed: Mar. 27, 2023
(86) PCT No.: PCT/JP2023/012262

§ 371 Date: Sep. 25, 2024

(30) Foreign Application Priority Data
Mar. 31, 2022 (JP) 2022-060550

(51) Int. Cl. H01M 10/0565

(52) U.S. Cl. CPC H01M 10/0565; H01M 2300/0082

(57) ABSTRACT

A polymer containing a structural unit (A) having an anion moiety with an alkali metal ion as a counter cation and a structural unit (B) having a functional group with a function as an anion receptor.

### TECHNICAL FIELD

The present disclosure relates to an alkali metal-containing polymer, and an electrolyte composition and a battery each containing the same.

### BACKGROUND ART

Lithium-ion batteries and the like have high capacities, and studies thereon are being actively conducted. As electrolytes for lithium-ion batteries, solutions of lithium salts containing organic solvents or ionic liquids are known, but studies on solid electrolytes are being conducted from the standpoint of safety and processability. Among others, polymers containing lithium ions are attracting attention for the following reasons (Patent Literature 1 and Non Patent Literatures 1 and 2).

In other words, polymers containing lithium ions have an advantage that polymers are highly flexible and therefore easily come into contact in solid electrolytes and at the interface with electrodes. In addition, as polymers containing lithium ions have counter anions of the lithium ions as functional groups of the polymers, the anions are fixed to the polymers, which makes it possible to suppress the migration of ions other than lithium ions during charging and discharging, and therefore only lithium ions can be substantially the single charge (that is, can be utilized as the single ion conductor (SIC).). In addition to lithium ion batteries, batteries that utilize ionic conduction of alkali metal ions such as sodium ions and potassium ions are also known.

### CITATION LIST

### Patent Literature

Patent Literature 1: Specification of Chinese Patent Application Publication No. 108878777

### Non Patent Literatures

Non Patent Literature 1: Li et al., “Single ion conducting lithium sulfur polymer batteries with improved safety and stability”, Journal of Materials Chemistry A, 2018, 6, p. 14330-14338.
Non Patent Literature 2: Du et al., “Water-Insoluble Side-Chain-Grafted Single Ion Conducting Polymer Electrolyte for Long-Term Stable Lithium Metal Secondary Batteries”, ACS Applied Energy Materials, 2020, 3, p. 1128-1138.

### SUMMARY OF INVENTION

### Technical Problem

Here, there are cases where alkali metal salts are further added to the electrolytes and the like of batteries in order to increase the ionic conductivity. However, in a case where an alkali metal salt is added, there is a problem that the transport number of the alkali metal ion decreases by the migration of the anion contained in the alkali metal salt.

The present disclosure has been made in view of the above circumstances, and an object thereof is to provide a polymer that can suppress a decrease in the transport number of an alkali metal ion in a case where an alkali metal salt is added thereto as well, and an electrolyte composition and a battery each containing the polymer.

### Solution to Problem

A polymer of the present disclosure contains a structural unit (A) having an anion moiety with an alkali metal ion as a counter cation and a structural unit (B) having a functional group with a function as an anion receptor.

The structural unit (B) may include at least one structural unit represented by the following Formula (B).

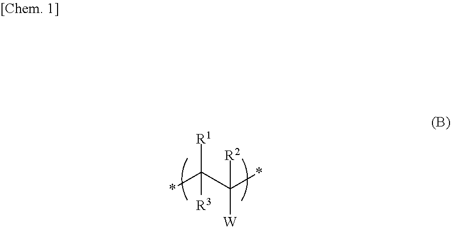

(In Formula (B), W is a functional group with a function as an anion receptor, R¹ to R³ are each independently a hydrogen atom or a monovalent substituent or R³ is a hydrogen atom or a monovalent substituent and R¹ and R² together form a divalent organic group, and * indicates a position where the structural unit (A) is bonded to another structural unit.)

The functional group may exhibit Lewis acidity.

The functional group may contain an electron-deficient atom.

The electron-deficient atom may be an atom belonging to Group 13 of the periodic table.

The structural unit (A) may have at least one functional group selected from the group consisting of a conjugate anion of a sulfonylimide group, a conjugate anion of a sulfonic acid group, and a conjugate anion of a phenolic hydroxyl group.

A molar ratio n of the structural unit (A) to all structural units contained in the polymer may be 0.2 to 0.8 and a molar ratio m of the structural unit (B) to all structural units contained in the polymer may be 0.2 to 0.8.

The content of the structural unit (A) may be 5% to 90% by mass and a content of the structural unit (B) may be 10% to 95% by mass with respect to a total amount of the polymer.

A polymer of the present disclosure may contain a structural unit (A) having an anion moiety with an alkali metal ion as a counter cation and a structural unit (B) represented by the following Formula (B).

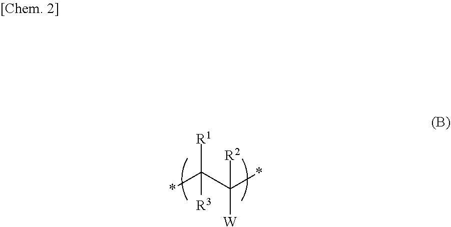

(In Formula (B), W is a functional group containing an electron-deficient atom, R¹ to R³ are each independently a hydrogen atom or a monovalent substituent or R³ is a hydrogen atom or a monovalent substituent and R¹ and R² together form a divalent organic group, and * indicates a position where the structural unit (B) is bonded to another structural unit.)

W may have a group represented by the following Formula (B1).

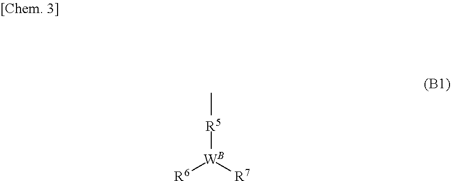

(In Formula (B1), W^{B} is an atom belonging to Group 13 of the periodic table, R⁵ is a covalent bond or a divalent organic group, and R⁶ and R⁷ are halogen atoms or monovalent organic groups or together form a divalent organic group.)

An electrolyte composition of the present disclosure contains the above-described polymer.

The electrolyte composition may further contain a plasticizer.

The electrolyte composition may further contain an alkali metal salt.

The electrolyte composition may further contain a fluorine-based resin.

A battery of the present disclosure contains the above-described polymer or the above-described electrolyte composition.

### Advantageous Effects of Invention

According to the present disclosure, it is possible to provide a polymer that can suppress a decrease in the transport number of an alkali metal ion in a case where an alkali metal salt is added thereto as well, and an electrolyte composition and a battery each containing the polymer.

### DESCRIPTION OF EMBODIMENTS

The polymer of the present embodiment contains a structural unit (A) having an anion moiety with an alkali metal ion as a counter cation and a structural unit (B) having a functional group with a function as an anion receptor. Such a polymer can suppress a decrease in the transport number of an alkali metal ion in a case of being used with an alkali metal salt in combination as well.

The structural unit (B) has a function as an anion receptor. An anion receptor refers to a chemical species that captures an anion by having electrostatic interaction with the anion or forming a hydrogen bond, acid-base complex, or the like with the anion. The structural unit (B) captures a counter anion of an alkali metal ion in an alkali metal salt to promote dissociation into the counter anion and the alkali metal ion. By this, the mobility of the alkali metal ion further increases. Meanwhile, since the counter anion is captured by the polymer via the structural unit (B), the mobility of the counter anion is suppressed, and as a result, it is considered that the transport number of the alkali metal ion is improved. Since the mobility of the alkali metal ion increases, the conductivity of the alkali metal ion also tends to be improved.

Low-molecular-weight chemical species (compounds and the like) that function as anion receptors are known, and examples of such chemical species include compounds described in the specification of U.S. Pat. No. 6,022,643, the specification of U.S. Pat. No. 5,705,689, and the specification of U.S. Pat. No. 6,120,941. The polymer of the present embodiment contains a structure corresponding to a chemical species that functions as an anion receptor as a functional group in the structural unit (B). Since the functional group is fixed to the polymer, the captured anion can be fixed onto the structure of the polymer, unlike conventional low-molecular-weight anion receptors. Therefore, it is considered that involvement of the anion in the electric current due to its migration can be more effectively suppressed.

The counter anion of the alkali metal salt does not need to be a free anion that is completely ionized when captured by the functional group, but may interact with the functional group and be captured in a state of forming an ionic bond or ion pair with an alkali metal ion.

The functional group with a function as an anion receptor may exhibit Lewis acidity. In this case, the functional group can capture an anion by accepting an unshared electron pair of the anion and forming an acid-base complex. Examples of such a functional group include functional groups containing an electron-deficient atom. An electron-deficient atom refers to an atom that is covalently bonded to another atom but of which the electrons in the outermost shell do not fulfill the octet rule. Examples of the electron-deficient atom include atoms belonging to Group 13 of the periodic table, and more specifically, the electron-deficient atom may be at least either of an aluminum atom or a boron atom, and may be a boron atom.

The functional group with a function as an anion receptor may be a group having an aza-ether moiety. A group having an aza-ether moiety is a group having an aza-ether compound as a substituent. Here, an aza-ether compound is a compound in which —O— in an ether compound is substituted with —NR^{E}— (where R^{E} is a hydrogen atom or an organic group). The aza-ether moiety may be either of a linear aza-ether moiety or a cyclic aza-ether moiety, and the group having an aza-ether moiety may have both a linear aza-ether moiety and a cyclic aza-ether moiety. The group having an aza-ether moiety may also have an electron-withdrawing group, for example, in the hydrocarbon moiety.

The structural unit (B) may include at least one structural unit represented by the following Formula (B).

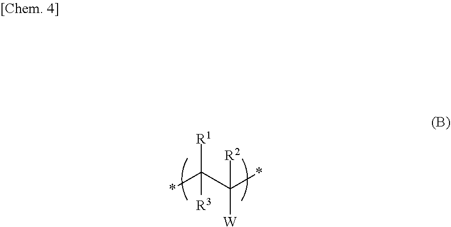

(In Formula (B), W is a functional group with a function as an anion receptor, R¹ to R³ are each independently a hydrogen atom or a monovalent substituent or R³ is a hydrogen atom or a monovalent substituent and R¹ and R² together form a divalent organic group, and * indicates the position where the structural unit (B) is bonded to another structural unit.)

One or more of R¹ to R³ may be hydrogen atoms, or all of R¹ to R³ may be hydrogen atoms. W may be a group represented by Formula (B1) described later.

In a case where R¹ to R³ are monovalent substituents, the monovalent substituents may be monovalent organic groups. The organic groups may have 1 to 20 carbon atoms, 1 to 15 carbon atoms, 1 to 10 carbon atoms, 1 to 5 carbon atoms, or 1 to 3 carbon atoms. Examples of the organic groups include monovalent substituents such as a hydrocarbon group and a group having a heterocycle such as a group having a chemical structure formed by substituting one or more carbon atoms (methylene groups) in the hydrocarbon group with a divalent linking group such as —O—, —S—, —C(═O)— or —C(═O)O—. The monovalent substituents may have a substituent that substitutes a hydrogen atom bonded to a carbon atom. Examples of the substituent include a halogen atom. The hydrocarbon group is not particularly limited, and may be an aliphatic hydrocarbon group, or may be an aromatic hydrocarbon group. The aliphatic hydrocarbon group may be any one of a straight-chain hydrocarbon group, a branched-chain hydrocarbon group, or a cyclic hydrocarbon group. The hydrocarbon group may be either of a saturated hydrocarbon group or an unsaturated hydrocarbon group. Examples of the hydrocarbon group include a methyl group, an ethyl group, a propyl group, and a phenyl group.

In the present specification, an aromatic hydrocarbon group is a group containing an aromatic moiety and may contain an aliphatic moiety. In the present specification, a cyclic hydrocarbon group is a group containing a cyclic hydrocarbon moiety and may contain a straight-chain or branched-chain hydrocarbon moiety.

The monovalent substituent may have an electron-withdrawing group or may be an electron-withdrawing group itself. The electron-withdrawing group may be bonded to the monovalent organic group, or the monovalent organic group may be the electron-withdrawing group. Examples of the electron-withdrawing group include a halogen atom, a sulfonic acid group or a salt thereof, a sulfonic acid ester, a nitro group, and a nitrile group. The halogen atom may be any one of a fluorine atom, a chlorine atom, a bromine atom or an iodine atom.

In a case where R¹ and R² together form a divalent organic group, the divalent organic group may have 1 to 20 carbon atoms, 1 to 15 carbon atoms, 1 to 10 carbon atoms, 1 to 5 carbon atoms, or 1 to 3 carbon atoms. Examples of the organic group include divalent substituents such as a hydrocarbon group, a divalent group having a chemical structure formed by substituting one or more carbon atoms (methylene groups) in a hydrocarbon group with a linking group of —O—, —S—, —C(═O)— or —C(═O)O—, and a group having a heterocycle. The divalent organic group may have a substituent that substitutes a hydrogen atom bonded to a carbon atom. Examples of the substituent include a halogen atom. The hydrocarbon group is not particularly limited, and may be an aliphatic hydrocarbon group or may be an aromatic hydrocarbon group. The aliphatic hydrocarbon group may be any one of a straight-chain hydrocarbon group, a branched-chain hydrocarbon group, or a cyclic hydrocarbon group. The hydrocarbon group may be either of a saturated hydrocarbon group or an unsaturated hydrocarbon group. Examples of the hydrocarbon group include a propylene group and a butylene group.

W may have a group represented by the following Formula (B1).

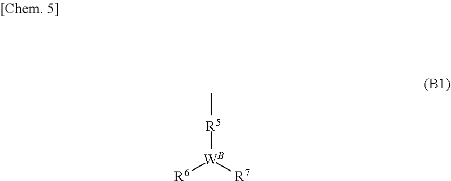

(In Formula (B1), W^{B} is an atom belonging to Group 13 of the periodic table, R⁵ is a covalent bond or a divalent organic group, and R⁶ and R⁷ are halogen atoms or monovalent organic groups or together form a divalent organic group. R⁶ and R⁷ may be the same group or different groups.)

W^{B} may be at least either of an aluminum atom or a boron atom, or may be a boron atom.

In a case where R⁵ is a divalent organic group, the divalent organic group may have 1 to 20 carbon atoms, 1 to 15 carbon atoms, 1 to 10 carbon atoms, 1 to 5 carbon atoms, or 1 to 3 carbon atoms. Examples of the organic group include divalent substituents such as a hydrocarbon group, a divalent group having a chemical structure formed by substituting one or more carbon atoms (methylene groups) in the hydrocarbon group with a divalent linking group such as —O—, —S—, —C(═O)— or —C(═O)O—, and a group having a heterocycle. The divalent organic group may have a substituent that substitutes a hydrogen atom bonded to a carbon atom. The substituent may be an electron-withdrawing group. Examples of the electron-withdrawing group include a halogen atom, a sulfonic acid group or a salt thereof, a sulfonic acid ester, a nitro group, and a nitrile group. The halogen atom may be any one of a fluorine atom, a chlorine atom, a bromine atom or an iodine atom. R⁵ may be a hydrocarbon group, a halogen-substituted hydrocarbon group, or a group in which a hydrocarbon group or a halogen-substituted hydrocarbon group is bonded to W^{B} via an ether bond. The halogen-substituted hydrocarbon group may be a hydrocarbon group in which some or all of the hydrogen atoms are substituted with halogen atoms, or may be a partially fluorine-substituted hydrocarbon group or a fully fluorine-substituted hydrocarbon group. R⁵ may be a covalent bond.

In a case where R⁶ or R⁷ is a halogen atom, R⁶ or R⁷ may be any one of a fluorine atom, a chlorine atom, a bromine atom or an iodine atom, or may be a fluorine atom.

In a case where R⁶ or R⁷ is a monovalent organic group, the monovalent organic group may have 1 to 20 carbon atoms, 1 to 15 carbon atoms, 1 to 10 carbon atoms, 1 to 5 carbon atoms, or 1 to 3 carbon atoms. Examples of the organic group include monovalent substituents such as a hydrocarbon group, a monovalent group having a chemical structure formed by substituting one or more carbon atoms (methylene groups) in the hydrocarbon group with a linking group of —O—, —S—, —C(═O)— or —C(═O)O—, and a group having a heterocycle. The monovalent organic group may have a substituent that substitutes a hydrogen atom bonded to a carbon atom. The substituent may be an electron-withdrawing group. Examples of the electron-withdrawing group include a halogen atom, a sulfonic acid group or a salt thereof, a sulfonic acid ester, a nitro group, and a nitrile group. The halogen atom may be any one of a fluorine atom, a chlorine atom, a bromine atom or an iodine atom. R⁶ or R⁷ may be a hydrocarbon group, a halogen-substituted hydrocarbon group, or a group in which a hydrocarbon group or a halogen-substituted hydrocarbon group is bonded to W^{B} via an ether bond. The halogen-substituted hydrocarbon group may be a hydrocarbon group in which some or all of the hydrogen atoms are substituted with halogen atoms, or may be a partially fluorine-substituted hydrocarbon group or a fully fluorine-substituted hydrocarbon group.

W may be a group represented by the following Formula (B1a) or a group represented by the following Formula (B1b).

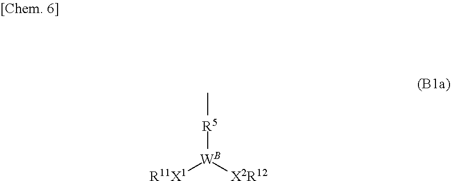

(In Formula (B1a), X¹ and X² are each an oxygen atom (ether bond) or a covalent bond, R¹¹ and R¹² are each a halogen atom, a monovalent hydrocarbon group, a hydrogen atom, or a monovalent halogen-substituted hydrocarbon group, and may be a halogen atom, a monovalent hydrocarbon group, or a monovalent halogen-substituted hydrocarbon group, and at least either of R¹¹ or R¹² may be a monovalent hydrocarbon group or a monovalent halogen-substituted hydrocarbon group. R¹¹ and R¹² may be the same group or different groups. R⁵ has the same meaning as R⁵ in Formula (B1).)

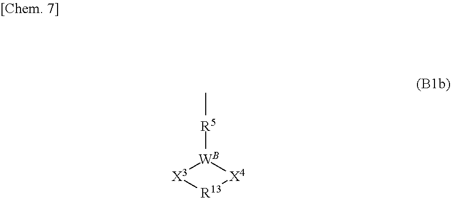

(In Formula (B1b), X³ and X⁴ are each an oxygen atom (ether bond) or a covalent bond, R¹³ is a divalent hydrocarbon group or a divalent halogen-substituted hydrocarbon group. R⁵ has the same meaning as R⁵ in Formula (B1).)

In Formula (B1a), in a case where R¹¹ is a halogen atom, X¹ may be a covalent bond. In a case where R¹² is a halogen atom, X² may be a covalent bond. In a case where R¹¹ or R¹² is a monovalent hydrocarbon group or a monovalent halogen-substituted hydrocarbon group, the monovalent hydrocarbon group or the monovalent halogen-substituted hydrocarbon group may have 1 to 20 carbon atoms, 1 to 15 carbon atoms, 1 to 10 carbon atoms, 1 to 5 carbon atoms, or 1 to 3 carbon atoms. The halogen-substituted hydrocarbon group may be a hydrocarbon group in which some or all of the hydrogen atoms are substituted with halogen atoms, or may be a partially fluorine-substituted hydrocarbon group or a fully fluorine-substituted hydrocarbon group.

R¹¹ and R¹² are each independently —F, —CH₃, —C₂H₅, —C₃H₇, —C₆H₅ (phenyl group), —C₆HₙF₅₋ₙ (n is an integer 0 to 4 and may be an integer 0 to 3), —CF₃, —CH₂CF₃, —CH₂CF₃F₇, —CH(CF₃)₂, —C(CF₃)₂-C₆H₅, —C(CF₃)₃, or —C₆Hₙ(CF₃)₅₋ₙ (n is an integer 0 to 4 and may be 1 or 2.)

In Formula (Bib), the divalent hydrocarbon group or the divalent halogen-substituted hydrocarbon group may have 1 to 20 carbon atoms, 1 to 15 carbon atoms, 2 to 10 carbon atoms, or 3 to 8 carbon atoms. The halogen-substituted hydrocarbon group may be a hydrocarbon group in which some or all of the hydrogen atoms are substituted with halogen atoms, or may be a partially fluorine-substituted hydrocarbon group or a fully fluorine-substituted hydrocarbon group.

Examples of R¹³ include divalent alkylene groups such as —C₂H₄—, —C₃H₆—, —C₄H₈—, —C₅H₁₀—, —C₆H₁₂—, —C₇H₁₄—, —C₈H₁₆—, —C₉H₁₈—, and —C₁₀H₂₀—; and those obtained by partially or fully substituting the hydrogen atoms in the divalent alkylene groups with fluorine. More specifically, R¹³ may be —C(CH₃)₂—C(CH₃)₂—.

The structural unit (A) has an alkali metal ion and a functional group (anionic functional group) having an anion moiety that is a counter cation of the alkali metal ion. Examples of the alkali metal ion include a lithium ion, a sodium ion, a potassium ion, a rubidium ion, and a cesium ion, and the alkali metal ion may be a lithium ion, a sodium ion, or a potassium ion, may be a lithium ion or a sodium ion, or may be a lithium ion.

The structural unit (A) may have at least one selected from the group consisting of a conjugate anion of a sulfonylimide group, a conjugate anion of a sulfonic acid group, and a conjugate anion of a phenolic hydroxyl group. The conjugate anion of a sulfonylimide group, the conjugate anion of a sulfonic acid group, and the conjugate anion of a phenolic hydroxyl group may be contained in, for example, a structural unit having a conjugate anion of a sulfonylimide group, a structural unit having a conjugate anion of a sulfonic acid group (sulfonate group), and a structural unit having a conjugate anion of a phenolic hydroxyl group, which will be described below.

The structural unit having a sulfonylimide group may be a structural unit represented by the following Formula (A1).

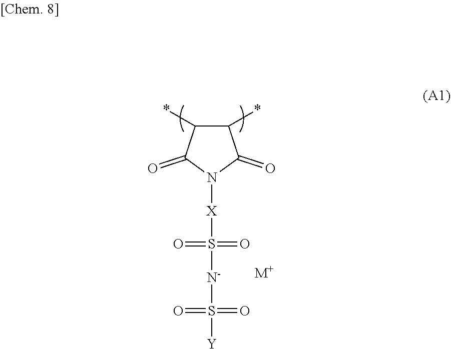

(In Formula (A1), X is a divalent organic group having 1 to 20 carbon atoms, Y is a halogen atom or a monovalent organic group having 1 to 20 carbon atoms, M is an alkali metal element and may be at least one alkali metal element selected from Li, Na, or K, and * indicates the position where the structural unit (A1) is bonded to another structural unit.)

X is not particularly limited, and may be a hydrocarbon group or a group containing a hetero atom, or may have a heterocycle. More specific examples of X include divalent groups such as a hydrocarbon group and a group having a chemical structure in which one or more carbon atoms (methylene groups) in a hydrocarbon group are substituted with a linking group such as —O—, —S—, —C(═O)— or —C(═O)O—. In a case where there are a plurality of linking groups, the linking groups are not adjacent to each other. The divalent group may have a substituent that substitutes a hydrogen atom bonded to a carbon atom. The substituent may be a monovalent substituent, and examples thereof include a halogen atom. The hydrocarbon group is not particularly limited, and may be an aliphatic hydrocarbon group or may be an aromatic hydrocarbon group. The aliphatic hydrocarbon group may be any one of a straight-chain hydrocarbon group, a branched-chain hydrocarbon group, or a cyclic hydrocarbon group. The hydrocarbon group may be either of a saturated hydrocarbon group or an unsaturated hydrocarbon group. X may be bonded to one or both of the nitrogen atom in a maleimide group and the sulfur atom in a sulfonyl group via a carbon atom contained in X.

X may have 1 to 15 carbon atoms, 2 to 10 carbon atoms, or 3 to 8 carbon atoms. X may be a group having an aromatic ring, or may be a group having an aromatic carbocyclic ring such as a benzene ring. A substituent such as an alkyl group, a halogen atom, or an electron-withdrawing group may be bonded to a carbon atom that is a member of the carbocyclic ring. The hydrocarbon group as X may be a phenylene group, an alkylene group having 1 to 8 carbon atoms, a polyoxyalkylene group, or groups in which some or all of the hydrogen atoms bonded to the carbon atoms contained in these groups are substituted with halogen atoms such as a fluorine atom, or may be a phenylene group or a substituted phenylene group substituted with an alkyl group, a halogen atom, an electron-withdrawing group, or the like. Examples of the electron-withdrawing group include a halogen atom, a sulfonic acid group or a salt thereof, a sulfonic acid ester, a nitro group, and a nitrile group.

In Formula (A), in a case where Y is a monovalent organic group, the organic group is not particularly limited, and may be a hydrocarbon group or a group containing a hetero atom, and may have a heterocycle. More specific examples of Y include monovalent groups such as a hydrocarbon group and a group having a chemical structure in which one or more carbon atoms (methylene groups) in a hydrocarbon group are substituted with a linking group such as —O—, —S—, —C(═O)— or —C(═O)O—. In a case where there are a plurality of linking groups, the linking groups are not adjacent to each other. The monovalent group may have a substituent that substitutes a hydrogen atom bonded to a carbon atom. The substituent may be a monovalent substituent, and examples thereof include a halogen atom. The hydrocarbon group is not particularly limited, and may be an aliphatic hydrocarbon group or may be an aromatic hydrocarbon group. The aliphatic hydrocarbon group may be any one of a straight-chain hydrocarbon group, a branched-chain hydrocarbon group, or a cyclic hydrocarbon group. The hydrocarbon group may be either of a saturated hydrocarbon group or an unsaturated hydrocarbon group.

Y may have 1 to 15 carbon atoms, 1 to 10 carbon atoms, 1 to 8 carbon atoms, 1 to 5 carbon atoms, or 1 to 3 carbon atoms. The hydrocarbon group as Y may be a phenyl group, an alkyl group having 1 to 5 carbon atoms, or groups in which some or all of the hydrogen atoms bonded to the carbon atoms contained in these groups are substituted with halogen atoms such as a fluorine atom, may be a fluorinated alkyl group having 1 to 5 carbon atoms, or may be a fluorinated alkyl group having 1 to 3 carbon atoms, such as a trifluoromethyl group. The fluorinated alkyl group may be a perfluorinated alkyl group. In a case where Y is a halogen atom, the halogen atom may be a fluorine atom or a chlorine atom, or may be a fluorine atom.

In Formula (A), M⁺ is an alkali metal ion, may be a lithium ion (Li⁺), a sodium ion (Na⁺), or a potassium ion (K⁺), or may be a lithium ion. M⁺ may include two or three ions among Li⁺, Na⁺, and K⁺, but may substantially include only a single ion.

The group having a conjugate anion of a phenolic hydroxyl group is a group having a group (that is, an —OM group where M is an alkali metal) formed by alkali metalating a hydroxyl group directly bonded to an aromatic ring (namely, a phenolic hydroxyl group (—OH)).

The structural unit (A) may be a structural unit represented by the following Formula (A2).

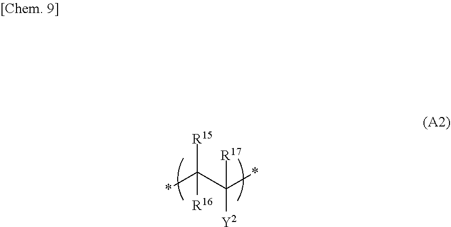

(In Formula (A2), Y² is a group having a phenolic hydroxyl group that is alkali metalated, or a group having a conjugate anion of a sulfonic acid, and * indicates the bonding position of the structural unit (A2) to another structural unit. R¹⁵ to R¹⁷ are each independently a hydrogen atom or a monovalent substituent or R¹⁶ is a hydrogen atom or a monovalent substituent and R¹⁵ and R¹⁷ together form a divalent substituent.)

One or more of R¹⁵ to R¹⁷ may be hydrogen atoms, or all of R¹⁵ to R¹⁷ may be hydrogen atoms.

In a case where R¹⁵ to R¹⁷ are monovalent substituents, the monovalent substituents may be monovalent organic groups. The organic groups may have 1 to 20 carbon atoms, 1 to 15 carbon atoms, 1 to 10 carbon atoms, 1 to 5 carbon atoms, or 1 to 3 carbon atoms. Examples of the organic group include monovalent substituents such as a hydrocarbon group and a group having a heterocycle such as a group having a chemical structure formed by substituting one or more carbon atoms (methylene groups) in the hydrocarbon group with a linking group of —O—, —S—, —C(═O)— or —C(═O)O—. The monovalent substituent may have a substituent that substitutes a hydrogen atom bonded to a carbon atom. Examples of the substituent include a halogen atom. The hydrocarbon group is not particularly limited, and may be an aliphatic hydrocarbon group or may be an aromatic hydrocarbon group. The aliphatic hydrocarbon group may be any one of a straight-chain hydrocarbon group, a branched-chain hydrocarbon group, or a cyclic hydrocarbon group. The hydrocarbon group may be either of a saturated hydrocarbon group or an unsaturated hydrocarbon group. Examples of the hydrocarbon group include a methyl group, an ethyl group, a propyl group, and a phenyl group.

With regard to R¹⁵ to R¹⁷, the monovalent substituent may have an electron-withdrawing group or may be an electron-withdrawing group itself. The electron-withdrawing group may be bonded to the monovalent organic group, or the monovalent organic group may be the electron-withdrawing group. Examples of the electron-withdrawing group include a halogen atom, a sulfonic acid group or a salt thereof, a sulfonic acid ester, a nitro group, and a nitrile group. The halogen atom may be any one of a fluorine atom, a chlorine atom, a bromine atom or an iodine atom.

In a case where R¹⁵ and R¹⁷ together form a divalent organic group, the divalent organic group may have 1 to 20 carbon atoms, 1 to 15 carbon atoms, 1 to 10 carbon atoms, 1 to 5 carbon atoms, or 1 to 3 carbon atoms. Examples of the organic group include divalent substituents such as a hydrocarbon group and a group having a heterocycle such as a group having a chemical structure formed by substituting one or more carbon atoms (methylene groups) in the hydrocarbon group with a linking group such as —O—, —S—, —C(═O)— or —C(═O)O—. The divalent organic group may have a substituent that substitutes a hydrogen atom bonded to a carbon atom. Examples of the substituent include a halogen atom. The hydrocarbon group is not particularly limited, and may be an aliphatic hydrocarbon group or may be an aromatic hydrocarbon group. The aliphatic hydrocarbon group may be any one of a straight-chain hydrocarbon group, a branched-chain hydrocarbon group, or a cyclic hydrocarbon group. The hydrocarbon group may be either of a saturated hydrocarbon group or an unsaturated hydrocarbon group. Examples of the hydrocarbon group include a propylene group and a butylene group.

In a case where Y² is a group having a phenolic hydroxyl group, Y² may be a group represented by any one of the following Formulas (A21) to (A26).

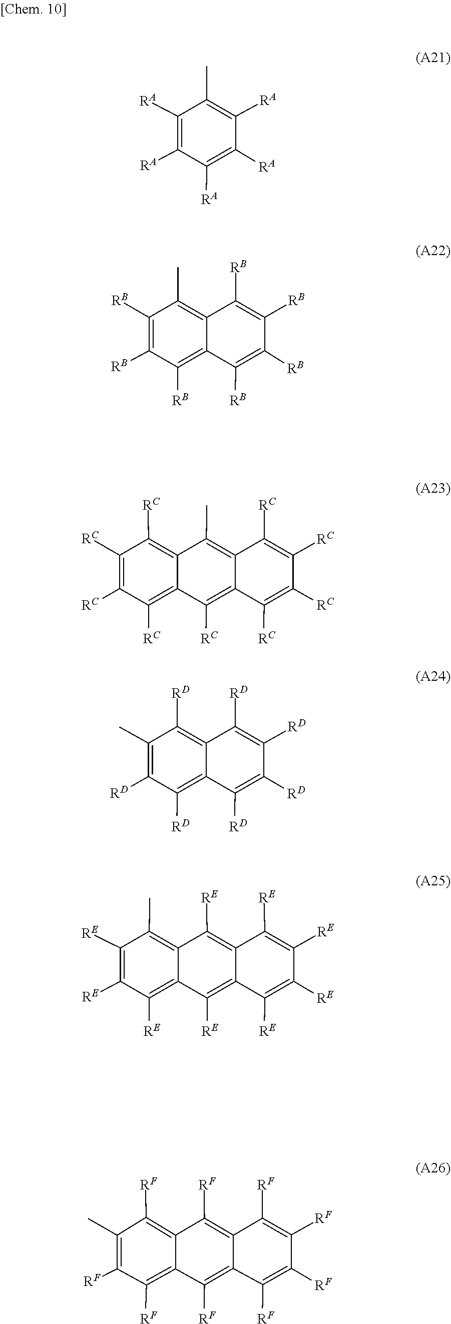

(In Formula (A21), at least one of R^{A} groups is an —OM group and the rest are hydrogen atoms or monovalent substituents, and M is an alkali metal element and may be Li, Na or K. In Formula (A22), at least one of R^{B} groups is an —OM group and the rest are hydrogen atoms or monovalent substituents, and M is an alkali metal element and may be Li, Na or K. In Formula (A23), at least one of R^{C} groups is an —OM group and the rest are hydrogen atoms or monovalent substituents, and M is an alkali metal element and may be Li, Na or K. In Formula (A24), at least one of R^{D} groups is an —OM group and the rest are hydrogen atoms or monovalent substituents, and M is an alkali metal element and may be Li, Na or K. In Formula (A25), at least one of R^{E} groups is an —OM group and the rest are hydrogen atoms or monovalent substituents, and M is an alkali metal element and may be Li, Na or K. In Formula (A26), at least one of R^{F} groups is an —OM group and the rest are hydrogen atoms or monovalent substituents, and M is an alkali metal element and may be Li, Na or K.)

The groups represented by Formulas (A21) to (A26) may have 1 to 3 —OM groups, may have 1 or 2 —OM groups, or may have 1 —OM group.

In Formulas (A21) to (A26), the monovalent substituent may be an electron-withdrawing group. Examples of the electron-withdrawing group include a halogen atom, a sulfonic acid group or a salt thereof, a sulfonic acid ester, a nitro group, and a nitrile group. The halogen atom may be any of F, Cl, Br or I, or may be F.

In Formulas (A21) to (A26), the monovalent substituent may be an organic group having 1 to 20 carbon atoms. The organic group may have 1 to 15 carbon atoms, 1 to 10 carbon atoms, 1 to 5 carbon atoms, or 1 to 3 carbon atoms. Examples of the organic group include monovalent groups such as a hydrocarbon group and a group having a heterocycle such as a group having a chemical structure formed by substituting one or more carbon atoms (methylene groups) in the hydrocarbon group with a linking group such as —O—, —S—, —C(═O)— or —C(═O)O—. The monovalent group may have a substituent that substitutes a hydrogen atom bonded to a carbon atom. Examples of the substituent include a halogen atom. The hydrocarbon group is not particularly limited, and may be an aliphatic hydrocarbon group or may be an aromatic hydrocarbon group. The aliphatic hydrocarbon group may be any one of a straight-chain hydrocarbon group, a branched-chain hydrocarbon group, or a cyclic hydrocarbon group. The hydrocarbon group may be either of a saturated hydrocarbon group or an unsaturated hydrocarbon group. Examples of the hydrocarbon group include a methyl group, an ethyl group, a propyl group, and a phenyl group. The monovalent organic group may itself be an electron-withdrawing group.

In a case where Y² is a group having a conjugate anion of a sulfonic acid, examples of Y² include a group represented by the following Formula (A3).

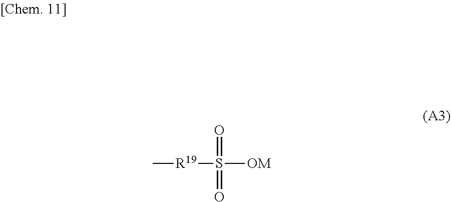

(In Formula (A3), R¹⁹ is a covalent bond or a divalent organic group. M is an alkali metal element and may be Li, Na or K.)

In Formula (A3), the divalent organic group may have 1 to 20 carbon atoms, 1 to 15 carbon atoms, 1 to 10 carbon atoms, 1 to 5 carbon atoms, or 1 to 3 carbon atoms. Examples of the organic group include divalent substituents such as a hydrocarbon group and a group having a heterocycle such as a group having a chemical structure formed by substituting one or more carbon atoms (methylene groups) in the hydrocarbon group with a linking group such as —O—, —S—, —C(═O)— or —C(═O)O—. The divalent organic group may have a substituent that substitutes a hydrogen atom bonded to a carbon atom. Examples of the substituent include a halogen atom. The hydrocarbon group is not particularly limited, and may be an aliphatic hydrocarbon group or may be an aromatic hydrocarbon group. The aliphatic hydrocarbon group may be any one of a straight-chain hydrocarbon group, a branched-chain hydrocarbon group, or a cyclic hydrocarbon group. The hydrocarbon group may be either of a saturated hydrocarbon group or an unsaturated hydrocarbon group. Examples of the hydrocarbon group include a methylene group and a phenylene group.

Examples of the group having a conjugate anion of a sulfonic acid include —SO³M, —CH₂—SO³M, and —C₆H₄—SO₃M.

The molar ratio m of the structural unit (B) to all structural units contained in the polymer may be 0.2 to 0.8, may be 0.25 to 0.75, may be 0.3 to 0.7, may be 0.35 to 0.65, or may be 0.4 to 0.6.

The molar ratio n of the structural unit (A) to all structural units contained in the polymer may be 0.25 to 0.75, may be 0.3 to 0.7, may be 0.35 to 0.65, or may be 0.4 to 0.6.

There is no problem if the sum of m and n is 1 or less, but the sum of m and n may be 0.95 or less. The sum of m and n may be 0.5 or more, may be 0.6 or more, may be 0.7 or more, may be 0.8 or more, may be 0.9 or more, or may be 0.95 or more.

The content of the structural unit (A) with respect to the total mass of the polymer may be 5% to 90% by mass, may be 20% to 80% by mass, may be 40% to 75% by mass, or may be 55% to 70% by mass.

The content of the structural unit (B) with respect to the total mass of the polymer may be 10% to 95% by mass, may be 20% to 80% by mass, may be 25% to 60% by mass, or may be 30% to 45% by mass.

The total content of the structural unit (A) and the structural unit (B) may be 50% by mass or more, 70% by mass or more, 90% by mass or more, or 95% by mass or more with respect to the total mass of the polymer.

The polymer may contain a structural unit (C) that is a structural unit different from both the structural unit (A) and the structural unit (B). Examples of the structural unit (C) include a structural unit represented by the following structural unit (C1) and a structural unit represented by the following structural unit (C2).

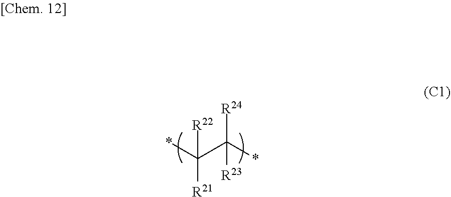

(In Formula (C1), R²¹ to R²⁴ are each independently a hydrogen atom, a halogen atom, or a monovalent organic group having 1 to 20 carbon atoms. * indicates the position where the structural unit (C1) is bonded to another structural unit.)

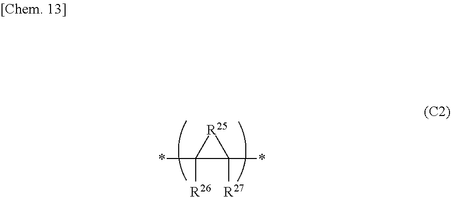

(In Formula (C2), R²⁵ is a divalent organic group having 1 to 20 carbon atoms, and R²⁶ and R²⁷ are each a hydrogen atom, a halogen atom, or a monovalent organic group having 1 to 20 carbon atoms.)

A structural unit (also referred to as a structural unit (Ap)) that is a precursor of the structural unit (A) may be contained in the structural unit (C). Examples of such a structural unit include unreacted structural units and intermediate structural units, which have not been converted into the structural unit (A), among structural units (for example, structural units derived from the monomer (A2′) described later), which are precursors of the structural unit (A), and examples thereof include a group that is a conjugate acid of the structural unit (A) (namely, a group in which the alkali metal ion that is the counter cation of the structural unit (A) is substituted with H⁺) and a group in which the counter cation of the structural unit (A) is substituted with a cation other than the alkali metal ion. Examples of the counter cation contained in the structural unit (Ap) include NH₄⁺, an organic ammonium cation, and a metal ion such as an alkaline earth metal ion. The polymer may contain the structural unit (A) at 85 mol % or more, 90 mol % or more, or 95 mol % or more with respect to the total amount of the structural unit (A) and the structural unit (Ap).

The polymer may contain a structural unit that is derived from a hydrocarbon compound having a plurality of ethylenically unsaturated groups, such as butadiene or isoprene.

The polymer may contain a structural unit derived from a crosslinking agent. Examples of the crosslinking agent include compounds having a plurality of ethylenically unsaturated groups in the molecule, such as hexanediol diacrylate, pentaerythritol tetraacrylate, divinylbenzene, and triethylene glycol divinyl ether.

The number average molecular weight (Mn) of the polymer may be 5000 to 200000, may be 8000 to 120000, or may be 10000 to 100000. The weight average molecular weight (Mw) of the polymer may be 5000 to 300000, may be 10000 to 250000, or may be 20000 to 100000. The molecular weight distribution (Mw/Mn) of the polymer may be 1.0 to 3.5, or may be 1.3 to 2.7. The number average molecular weight and weight average molecular weight of the polymer can be measured by, for example, gel permeation chromatography.

The polymer of the present embodiment can be used as an ion-conductive material and can be used as a material for batteries. In other words, the battery of the present embodiment contains the above-described polymer. The polymer may be contained in an electrolyte composition that constitutes the electrolyte of the battery. Examples of the battery include a lithium ion battery, a sodium ion battery, and a potassium ion battery. The battery includes a positive electrode, a negative electrode, and an electrolyte disposed between the positive electrode and the negative electrode, and the electrolyte may contain the polymer. In other words, the polymer of the present embodiment can be used as an electrolyte material.

The electrolyte composition may contain a plasticizer. The plasticizer may be an organic solvent or may be an aprotic solvent. The organic solvent may be at least one selected from the group consisting of a carbonate-based solvent, a fluorine-based solvent, and an ether-based solvent, and these solvents may be aprotic solvents. When a plasticizer is used, the electrolyte composition tends to be easily molded. Examples of the carbonate-based solvent include chain carbonates such as dimethyl carbonate, diethyl carbonate, and ethyl methyl carbonate; and cyclic carbonates such as ethylene carbonate, propylene carbonate, butylene carbonate, and vinylene carbonate. Examples of the ether-based solvent include cyclic ethers such as tetrahydrofuran, 2-methyltetrahydrofuran, tetrahydropyran, and 1,3-dioxolane; and chain ethers such as 1,2-diethoxyethane and ethoxymethoxyethane. Examples of the fluorine-based solvent include hydrofluorocarbons such as perfluorooctane; hydrofluoroethers such as methyl nonafluorobutyl ether and ethyl nonafluorobutyl ether; and hydrofluoroolefins such as 1,3,3,3-tetrafluoropropene. Examples of the solvent include aprotic solvents such as dimethylsulfoxide (DMSO); and amide-based solvents such as dimethylformamide (DMF) and dimethylacetamide (DMA). The organic solvents may be used singly or as a mixed solvent containing two or more organic solvents.

The content of the organic solvent in the electrolyte composition may be 20 to 600 parts by mass, 50 to 400 parts by mass, or 80 to 300 parts by mass with respect to 100 parts by mass of the polymer.

The electrolyte composition may contain another resin. Examples of another resin include a fluorine-based resin. The fluorine-based resin may have a carbon chain as the main chain, and examples thereof include a homopolymer or copolymer of a monomer having fluorine and an ethylenically unsaturated group. Specific examples of the fluorine-based resin include polyvinylidene fluoride and polyvinylidene fluoride-hexafluoropropylene copolymer.

The electrolyte composition may contain an alkali metal salt in addition to the polymer. The alkali metal salt is not particularly limited, but examples thereof include MF, MCl, MBr, MI, MClO₄, MPF₆, MBF₄, M₂SO₄, M[(CₕF₂ₕ₊₁)SO₂]₂N (h is 0 to 3), and M[(CₕF₂ₕ₊₁)SO₂N⁻SO₂(CᵢF₂ᵢ₊₁)], where M is an alkali metal. M may be the same alkali metal as in the structural unit (A). M may be lithium, sodium or potassium. The content of the alkali metal salt in the electrolyte composition may be 100 mol % or less or 75 mol % or less, in terms of alkali metal ion, with respect to the content of the structural unit (B) in the polymer.

### <Method for Producing Polymer>

The method for producing the polymer is not particularly limited, but examples thereof include a method in which monomers (monomer mixture) including a monomer having an anionic functional group ionized with an alkali metal or a monomer having a precursor of the anionic functional group (hereinafter referred to as monomer (A′)) and a monomer (B′) having a functional group with a function as an anion receptor. The monomers may further include a monomer (C′) different from the monomer (A′) and the monomer (B′).

The monomer (A′) and the monomer (B′) may have an ethylenically unsaturated group. In this case, the monomer (A′) and the monomer (B′) can be polymerized by radical addition polymerization. In this case, the monomers can be polymerized in the presence of an initiator. In other words, the polymerization reaction may be conducted in a polymerizable composition containing the monomers and an initiator.

The monomer (A′) is a monomer which induces the structural unit (A) in the polymer. Examples of the monomer (A′) include a monomer (A1′) represented by the following Formula (A1′) and a monomer (A2′) represented by the following Formula (A2′).

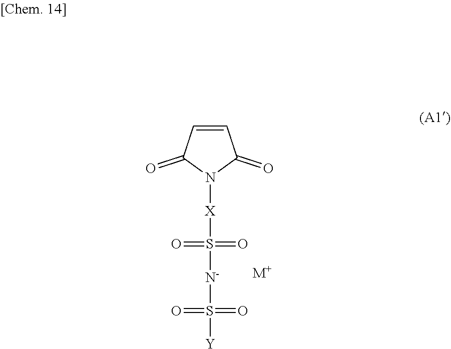

(X, Y and M⁺ in Formula (A1′) have the same meanings as in Formula (A).)

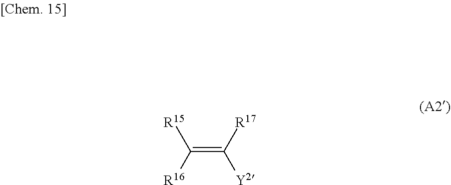

(In Formula (A2′), R¹⁵ to R¹⁷ have the same meanings as R¹⁵ to R¹⁷ in Formula (A2), and Y²′ is a group having a group capable of inducing a phenolic hydroxyl group that corresponds to the —OM group of Y² in Formula (A2) or a group capable of inducing a sulfonic acid group that corresponds to the —SO₃M group of Y².)

Y^{2′} may be the same group as Y², but may also be a group that is a precursor of Y². In other words, Y^{2′} is a group having a group that can be converted into an —OM group or —SO₃M group at the same position as the —OM group or —SO₃M group of Y² to be obtained.

Examples of the group capable of inducing a phenolic hydroxyl group that corresponds to the —OM group of Y² include a hydrolyzable group, and a phenolic hydroxyl group can be introduced into the position corresponding to the —OM group of Y² by hydrolyzing the hydrolyzable group. Examples of the hydrolyzable group include an alkoxide group or an —OSi(R^{k})₃ group (R^{k} is a monovalent organic group such as a hydrocarbon group). The phenolic hydroxyl group can be converted into an —OM group, for example, by being reacted with a basic salt of an alkali metal such as MOH, M₂CO₃, or MHCO₃.

Similarly, examples of the group capable of inducing a sulfonic acid group that corresponds to the —SO₃M group of Y² include groups capable of inducing a sulfonic acid group (—SO₃H), such as a sulfonic acid ester group and a —SO₂Cl group. The sulfonic acid group can be converted into an —OM group, for example, by being reacted with a salt of an alkali metal such as MOH, M₂CO₃, MHCO₃, or an alkali metal halide. The —SO₂Cl group can also be converted into a —SO₃M group by being reacted with MOH. In a case where an excess of MOH is used, most of the —SO₂Cl groups can also be converted into —SO₃M groups. In such a reaction, some of the —SO₂Cl groups are converted into —SO₃H groups in some cases, but the —SO₃H groups may be converted into —SO₃M groups by being separately reacted with abase containing M. Y^{2′} may be a group that has the same anion moiety as in Y² and forms a salt with a cation other than an alkali metal ion. In this case, the structural unit (A2) can be induced by subjecting the obtained polymer to a cation exchange reaction. The reaction rate of Y2′ (the proportion of Y^{2′} converted into Y² to the total amount of Y^{2′}) may be 85 mol % or more, 90 mol % or more, or 95 mol % or more.

The monomer (B′) is a monomer which induces the structural unit (B) in the polymer. Examples of the monomer (B′) include a monomer (B′) represented by the following Formula (B′).

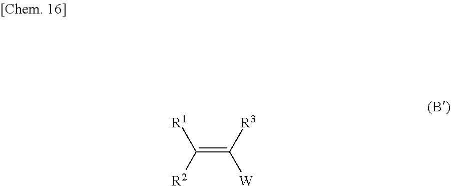

(In the formula, R¹ to R³ and W have the same meanings as R¹ to R³ and W in Formula (B).)

The radical polymerization initiator may be either of a thermal initiator or a photoinitiator. Examples of the thermal initiator include 2,2-azobis(isobutyronitrile) (AIBN); azo initiators such as 2,2-azobis(2-methylbutyronitrile) (AMBN), 2,2-azobis(2,4-dimethylvaleronitrile) (ADVN), 1,1-azobis(1-cyclohexanecarbonitrile) (ACHN, V-40), and dimethyl-2,2-azobisisobutyrate (MAIB); and organic peroxides such as dibenzoyl peroxide, di-8,5,5-trimethylhexanoyl peroxide, dilauroyl peroxide, didecanoyl peroxide, and di(2,4-dichlorobenzoyl) peroxide. Examples of the photoinitiator include oxime-based compounds, metallocene-based compounds, acylphosphine-based compounds, and aminoacetophenone compounds. One or two or more initiators may be used.

The polymerizable composition may contain a chain transfer agent such as carbon tetrachloride.

### EXAMPLES

### (Production of Monomer (A1) and Monomer (B1))

The monomer (A1) and monomer (B1) were prepared as described below.

### (Synthesis of Monomer A1)

In a nitrogen atmosphere, trifluoromethanesulfonamide (52.5 mmol, 7.83 g, manufactured by Tokyo Chemical Industry Co., Ltd.) was dissolved in dehydrated acetonitrile (150 mL, manufactured by KANTO CHEMICAL CO., INC.). To this solution, lithium hydroxide (105 mmol, 2.51 g, manufactured by Tokyo Chemical Industry Co., Ltd.) and 4-acetamidobenzenesulfonyl chloride (50 mmol, 11.68 g, manufactured by Tokyo Chemical Industry Co., Ltd.) were added in this order, and heating was performed under reflux for 5 hours. After cooling to room temperature was performed, a solid was precipitated by addition of an excess of acetonitrile (700 mL), separated through filtration, and then washed with dichloromethane (manufactured by KANTO CHEMICAL CO., INC.) to obtain an intermediate 1. The yield was 97.1%.

### Structural Formula of Intermediate 1:

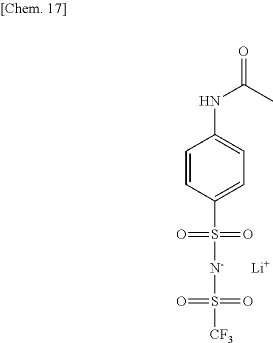 [SMILES: CC(=O)Nc1ccc(S(=O)(=O)[N-]S(=O)(=O)C(F)(F)F)cc1 ; [Li+]]

In a nitrogen atmosphere, 5% hydrochloric acid (22.5 mL) was added to the intermediate 1 (15 mmol, 5.28 g), and stirring was performed at 90° C. for 2 hours. After cooling to room temperature was performed, an aqueous solution of lithium hydroxide was added until the pH reached 7 or more while the pH was checked with pH test paper or the like, and then drying under reduced pressure was performed to obtain a solid. The obtained solid was subjected to extraction with an acetonitrile solution, and drying under reduced pressure was performed to obtain an intermediate 2. The yield was 92.6% based on the raw materials of the intermediate 1.

### Structural Formula of Intermediate 2:

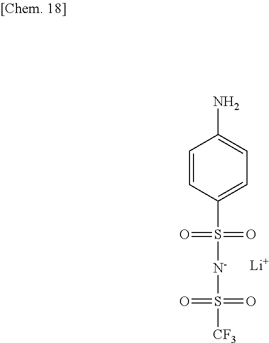 [SMILES: Nc1ccc(S(=O)(=O)[N-]S(=O)(=O)C(F)(F)F)cc1 ; [Li+]]

In a nitrogen atmosphere, maleic anhydride (13.3 mmol, 1.30 g, manufactured by Tokyo Chemical Industry Co., Ltd.) was dissolved in dehydrated 1,4-dioxane (manufactured by KANTO CHEMICAL CO., INC.). To this solution, the entire amount of a solution of intermediate 2 (13.2 mmol, 4.09 g) in dehydrated tetrahydrofuran (26.4 mL, manufactured by KANTO CHEMICAL CO., INC.) prepared in a nitrogen atmosphere was added dropwise, and stirring was performed at room temperature for 12 hours. After the reaction, the precipitate was filtered and dried in a vacuum at 60° C. for 4 hours to obtain a solid containing an intermediate 3.

### Structural Formula of Intermediate 3:

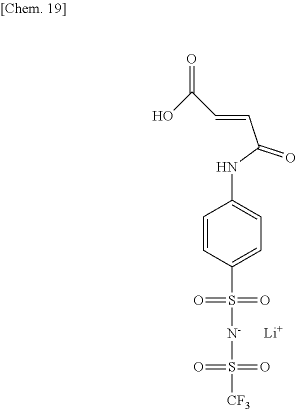 [SMILES: O=C(O)/C=C/C(=O)Nc1ccc(S(=O)(=O)[N-]S(=O)(=O)C(F)(F)F)cc1 ; [Li+]]

In a nitrogen atmosphere, the solid containing the intermediate 3 (14.0 mmol, 5.70 g) and an aqueous solution of sodium acetate (13.3 mmol, 1.09 g, manufactured by Tokyo Chemical Industry Co., Ltd.) were added to acetic anhydride (12.3 mL, manufactured by Tokyo Chemical Industry Co., Ltd.), and stirring was performed at 70° C. for 3 hours. The entire amount of the solution after the reaction was added dropwise to an excess of diethyl ether (manufactured by KANTO CHEMICAL CO., INC.) at 0° C., and the precipitate was collected through filtration. The precipitate was subjected to extraction with dehydrated acetonitrile (manufactured by KANTO CHEMICAL CO., INC.) in an inert atmosphere, and drying under reduced pressure was performed to obtain A1. The yield throughout the whole process was 72.8%.

### Monomer A1: The Following Compound (A1)

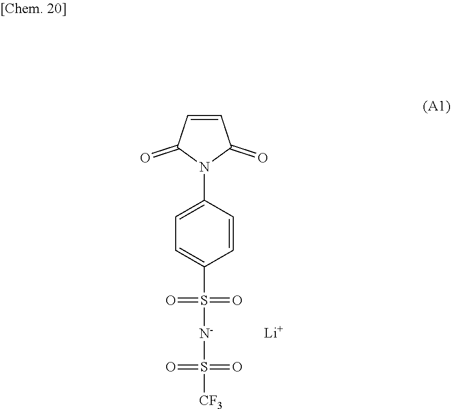 [SMILES: O=C1C=CC(=O)N1c1ccc(S(=O)(=O)[N-]S(=O)(=O)C(F)(F)F)cc1 ; [Li+]]

### (Synthesis of Monomer B1)

The monomer B1 (the following Formula (B1)) was synthesized as follows.

To a cloudy solution obtained by adding 175 mL of diethyl ether to 4.21 g (5 mmol) of anhydrous magnesium sulfate (MgSO₄) and 4.14 g (35 mmol) of pinacol and performing stirring, 4-vinylphenylboronic acid (VPBA, 5.18 g (35 mmol) was added, and stirring was performed at room temperature for 19 hours. The solution obtained through filtration was evaporated and purified by silica gel chromatography (eluent: hexane/ethyl acetate 20/1 (volume ratio)) to obtain the desired monomer B1 at a yield of 92.1%.

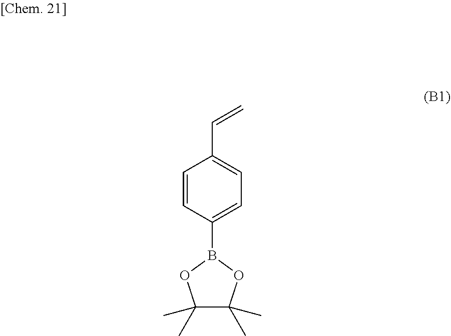

### (Production of Copolymer 1)

The solutions of the respective components were mixed so that the monomer A1 was 0.78 g, the monomer B1 was 0.46 g, and the azobisisobutyronitrile (AIBN) was 16.4 mg, and the reaction was conducted at 60° C. for 24 hours in a nitrogen atmosphere while the monomer consumption rate was checked by the addition of tetralin as an internal standard substance. Acetonitrile was used as the solvent. The solution after the reaction was dialyzed in acetonitrile, and drying was performed in a vacuum at 120° C. to obtain a copolymer 1 by 1.08 g (yield 87%). The monomer introduction ratio was A1:B1=48:52. The monomer introduction ratio was calculated from ¹H-NMR of the copolymer 1.

The copolymer 1 had a number average molecular weight Mn of 7.4×10⁴, a weight average molecular weight Mw of 1.8×10⁵, and a molecular weight distribution Mw/Mn of 2.40.

### (Production of Copolymer 2)

The monomer A1: 0.558 g, styrene: 0.149 g, and azobisisobutyronitrile (AIBN): 11.7 mg were dissolved in dehydrated acetonitrile: 13.4 mL, and the reaction was conducted at 60° C. for 24 hours in a nitrogen atmosphere while the monomer consumption rate was checked by the addition of tetralin as an internal standard substance. The polymerization solution was dialyzed in acetonitrile, and drying was performed in a vacuum at 120° C. to obtain a copolymer 2 by 0.64 g (yield 87%). The monomer introduction ratio was A1:styrene=52:48.

The monomer introduction ratio was calculated from ¹H-NMR of the copolymer 2.

The copolymer 2 had a number average molecular weight Mn of 8.7×10⁴, a weight average molecular weight Mw of 2.2×10⁵, and a molecular weight distribution Mw/Mn of 2.55.

### Example 1

A mixed solvent of ethylene carbonate and propylene carbonate (volume ratio 1:1) as a plasticizer was added to the copolymer 1 at 200% by mass to produce an electrolyte composition.

### <Measurement of Ionic Conductivity>

An evaluation cell of a coin-type battery CR2032 was assembled in a glove box in a dry argon atmosphere. Specifically, the respective layers were layered in an evaluation cell in the following order to fabricate a layered body for test.

### (Stainless Steel Plate/Electrolyte Composition/Stainless Steel Plate)

Using an impedance measuring device, the measurement is performed under conditions of 25° C., a frequency range of 0.1 Hz to 1 MHz, and an applied voltage of 10 mV (vs. open circuit voltage). The ionic conductivity σ can be calculated using the following equation.

$$σ ( S \cdot {cm}^{1} ) = t ( cm ) / R ( Ω ) \times A ( {cm}^{2} ) )$$

In the equation, R denotes the impedance value. A denotes the area of the sample. t denotes the thickness of the sample. The results are presented in Table 1.

### <Measurement of Activation Energy>

The ionic conductivity measurement using the evaluation cell was also carried out under conditions of 30° C., 40° C., 50° C., 60° C., and 70° C. to measure the changes in ionic conductivity depending on the temperature. The activation energy was calculated from the slope of a graph of the common logarithm value of ionic conductivity versus the reciprocal of temperature using the Arrhenius equation (log k=log A−Ea/RT, k: reaction rate constant, A: frequency factor, Ea: activation energy, R: gas constant, T: absolute temperature).

### <Measurement of Lithium Ion Transport Number>

An evaluation cell of a coin-type lithium battery CR2032 was assembled in a glove box in a dry argon atmosphere. Specifically, the respective layers were layered in an evaluation cell in the following order to fabricate a layered body for test. (Lithium/electrolyte composition/lithium)

A voltage of 10 mV was applied to the layered body for test at room temperature (25° C.), and the initial current value (I₀) and the steady-state current value (Iₛₛ) after 10000 seconds were measured. The obtained values were inserted into the following equation to determine the lithium ion transport number (t_{Li+}).

$${t}_{Li +} = {I}_{ss} / {I}_{0}$$

### Example 2

An electrolyte composition was produced in the same manner as in Example 1 except that lithium bis(fluorosulfonyl)imide (LiFSI) was further added to the structural unit (B) of the copolymer at 50 mol %, and various kinds of measurements were carried out.

### Comparative Example 1

An electrolyte composition was produced in the same manner as in Example 1 except that the copolymer 1 was changed to the copolymer 2, and various kinds of measurement were carried out.

### Comparative Example 2

An electrolyte composition was produced in the same manner as in Comparative Example 1 except that lithium bis(fluorosulfonyl)imide (LiFSI) was further added to the structural unit (B) of the copolymer at 50 mol %, and various kinds of measurements were carried out.

TABLE 1

| | Copolymer | LiFSI | Plasticizer | σ | Ea | |
|---|---|---|---|---|---|---|
| | (% by mass) | (mol %) | (% by mass) | (S · cm⁻¹) | (kJ/mol) | t_{Li+} |
| Example 1 | Copolymer 1 | — | 200 | 0.32 | 18.2 | 0.86 |
| Example 2 | Copolymer 1 | 50 | 200 | 0.44 | 19.4 | 0.71 |
| Comparative | Copolymer 2 | — | 200 | 0.53 | 18.8 | 0.80 |
| Example 1 | | | | | | |
| Comparative | Copolymer 2 | 50 | 200 | 0.83 | 19.0 | 0.59 |
| Example 2 | | | | | | |

When Examples 1 and 2 were compared with each other, in Example 2 in which a lithium salt was added, 83% of the lithium ion transport number in Example 1 was retained although the lithium ion transport number decreased. On the other hand, in Comparative Examples 1 and 2, the lithium ion transport number itself was lower than that in Examples 1 and 2. In Comparative Example 2, only 73% of the lithium ion transport number in Comparative Example 1 was retained, and the degree of the lithium ion transport number decreasing rate was large.

### Example 3

A mixed solvent of ethylene carbonate and propylene carbonate (volume ratio 1:1) as a plasticizer and a fluorine-based resin were added to the copolymer 1 at 400% by mass and 100% by mass, respectively to produce an electrolyte composition. Various kinds of measurement were carried out in the same manner as in Example 1. The results are presented in Table 2. The fluorine-based resin used was polyvinylidene fluoride-hexafluoropropylene copolymer (PVDF-HFP, manufactured by Sigma-Aldrich Corporation, Mw: 400000 or less, Mn: 130000 or less, pellet form, product number: 427160).

### Example 4

An electrolyte composition was produced in the same manner as in Example 3 except that lithium bis(fluorosulfonyl)imide (LiFSI) was further added to the structural unit (B) of the copolymer at 50 mol %, and various kinds of measurements were carried out. The results are presented in Table 2.

### Comparative Example 3

An electrolyte composition was produced in the same manner as in Example 4 except that the copolymer 1 was changed to the copolymer 2, and various kinds of measurement were carried out. The results are presented in Table 2.

TABLE 2

| | Copolymer | PVDF-HFP | LiFSI | Plasticizer | σ | Ea | |
|---|---|---|---|---|---|---|---|
| | (% by mass) | (% by mass) | (mol %) | (% by mass) | (S · cm⁻¹) | (kJ/mol) | t_{Li+} |
| Example 1 | Copolymer 1 | — | — | 200 | 0.32 | 18.2 | 0.86 |
| Example 3 | Copolymer 1 | 100 | — | 400 | 0.20 | 15.2 | 0.90 |
| Example 4 | Copolymer 1 | 100 | 50 | 400 | 0.22 | 17.6 | 0.75 |
| Comparative | Copolymer 2 | — | — | 200 | 0.53 | 18.8 | 0.80 |
| Example 1 | | | | | | | |
| Comparative | Copolymer 2 | 100 | 50 | 400 | 0.20 | 20.3 | 0.53 |
| Example 3 | | | | | | | |

In a case where the copolymer 1 was compounded with a fluorine-based resin as well, the retention rate of the lithium ion transport number when a lithium salt was added was high as in the cases of Example 1 and Example 2. On the other hand, in Comparative Example 3, the lithium ion transport number significantly decreased compared to that in Example 4.

### Examples 5 and 6

An electrolyte composition was produced in the same manner as in Example 2 except that LiBF₄ was used as the lithium salt instead of LiFSI, and various kinds of measurements were carried out as in Example 5.

An electrolyte composition was produced in the same manner as in Example 4 except that LiTFSI was used as the lithium salt instead of LiFSI, and various kinds of measurements were carried out as in Example 6.

The respective results are presented in Table 3.

TABLE 3

| | Copolymer | PVDF-HFP | Lithium salt | | Plasticizer | σ | Ea | |
|---|---|---|---|---|---|---|---|---|
| | (% by mass) | (% by mass) | (mol %) | | (% by mass) | (S · cm⁻¹) | (kJ/mol) | t_{Li+} |
| Example 1 | Copolymer 1 | — | — | — | 200 | 0.32 | 18.2 | 0.86 |
| Example 2 | Copolymer 1 | — | LiFSI | 50 | 200 | 0.44 | 19.4 | 0.71 |
| Example 5 | Copolymer 1 | — | LiBF₄ | 50 | 200 | 0.51 | 20.4 | 0.73 |
| Example 3 | Copolymer 1 | 100 | — | — | 400 | 0.20 | 15.2 | 0.90 |
| Example 4 | Copolymer 1 | 100 | LiFSI | 50 | 400 | 0.22 | 17.6 | 0.75 |
| Example 6 | Copolymer 1 | 100 | LiTFSI | 50 | 400 | 0.22 | 16.8 | 0.72 |

The copolymer 1 maintained a high lithium ion transport number when LiBF₄ or LiTFSI was added instead of LiFSI as well.

1. A polymer comprising a structural unit (A) having an anion moiety with an alkali metal ion as a counter cation and a structural unit (B) having a functional group with a function as an anion receptor.

2. The polymer according to claim 1, wherein the structural unit (B) includes at least one structural unit represented by the following Formula (B): 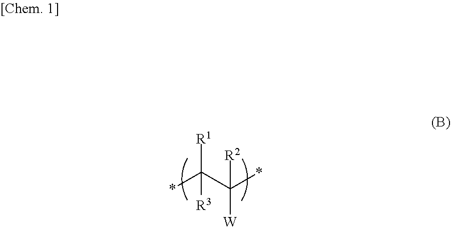
(in Formula (B), W is a functional group with a function as an anion receptor, R¹ to R³ are each independently a hydrogen atom or a monovalent substituent or R³ is a hydrogen atom or a monovalent substituent and R¹ and R² together form a divalent organic group, and * indicates a position where the structural unit (B) is bonded to another structural unit).

3. The polymer according to claim 1, wherein the functional group exhibits Lewis acidity.

4. The polymer according to claim 1, wherein the functional group contains an electron-deficient atom.

5. The polymer according to claim 4, wherein the electron-deficient atom is an atom belonging to Group 13 of the periodic table.

6. The polymer according to claim 1, wherein the structural unit (A) has at least one functional group selected from the group consisting of a conjugate anion of a sulfonylimide group, a conjugate anion of a sulfonic acid group, and a conjugate anion of a phenolic hydroxyl group.

7. The polymer according to claim 1, wherein a molar ratio n of the structural unit (A) to all structural units contained in the polymer is 0.2 to 0.8 and a molar ratio m of the structural unit (B) to all structural units contained in the polymer is 0.2 to 0.8.

8. The polymer according to claim 1, wherein a content of the structural unit (A) is 5% to 90% by mass and a content of the structural unit (B) is 10% to 95% by mass with respect to a total amount of the polymer.

9. A polymer comprising a structural unit (A) having an anion moiety with an alkali metal ion as a counter cation and a structural unit (B) represented by the following Formula (B): 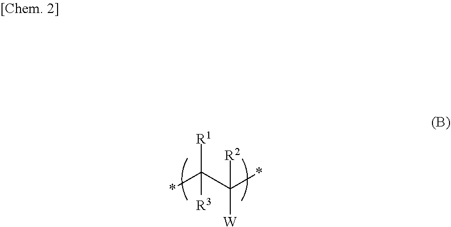
(in Formula (B), W is a functional group containing an electron-deficient atom, R¹ to R³ are each independently a hydrogen atom or a monovalent substituent or R³ is a hydrogen atom or a monovalent substituent and R¹ and R² together form a divalent organic group, and * indicates a position where the structural unit (B) is bonded to another structural unit).

10. The polymer according to claim 9, wherein W has a group represented by the following Formula (B1): 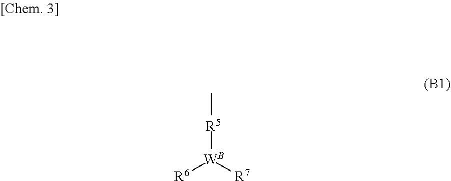
(in Formula (B1), W^{B} is an atom belonging to Group 13 of the periodic table, R⁵ is a covalent bond or a divalent organic group, and R⁶ and R⁷ are halogen atoms or monovalent organic groups or together form a divalent organic group).

11. An electrolyte composition comprising the polymer according to claim 1.

12. The electrolyte composition according to claim 11, further comprising a plasticizer.

13. The electrolyte composition according to claim 11, further comprising an alkali metal salt.

14. The electrolyte composition according to claim 11, further comprising a fluorine-based resin.

15. A battery comprising the polymer according to claim 1.
